(19) United States
(12) Patent Application Publication
(10) Pub. No.: US 2003/0194239 A1
(43) Pub. Date: Oct. 16, 2003

(54) In-car infrared receiving apparatus for shielding interference light

(76) Inventor: Tsao-I Shih, Taipei (TW)

Correspondence Address: Tsao-I Shih, P.O. Box 55-846, Taipei, 104, TW

(21) Appl. No.: 10/302,303

(22) Filed: Nov. 19, 2002

(30) Foreign Application Priority Data
Apr. 10, 2002 (TW) 91204615

(51) Int. Cl. H04B 10/00

(52) U.S. Cl. 398/140

(57) ABSTRACT

An infrared receiving apparatus includes: a housing having an earphone adapted to be worn on a car driver's ear, an infrared (IR) receiver for receiving infrared signal as transmitted by an IR transmitter electrically connected to a cellular phone held in a car and for converting the IR signal to be audio signal to be heard by the car driver through the earphone as worn thereon, and a rotary shielding cover pivotally mounted in the housing and having an opening formed in a peripheral portion of the rotary shielding cover having a pendulum weight secured to the peripheral portion of the cover as juxtapositioned to the opening, thereby causing the cover to be gravitationally pendent to constantly orient the opening of the cover downwardly to preclude the inward projection of interference sunlight, and to exclusively allow the entrance of the IR signals from the cellular phone through the opening as gravitationally positioned at a bottom portion of the shielding cover to prevent from unexpected interference lights and to maintain a good communication quality for cellular-phone talk when driving a car.

### BACKGROUND OF THE INVENTION

It is very dangerous to pick up a cellular phone by hand for a phone talk when driving a car because the driver may have his or her single hand holding the steering wheel, thereby causing an unsafe driving.

Even the cellular phone may be provided with wires for connecting the microphone and ear phone to the driver's mouth and ear, the wires may tangle the driver's movement whenever driving the car, still causing inconvenience to the driver.

A wireless infrared (IR) system may be provided for overcoming the above-mentioned drawbacks for receiving infrared signal as transmitted from an IR transmitter electrically connected to the cellular phone. However, any incoming light such as strong sun light having infrared rays existing therein may cover or interfere the “weak” infrared signals between the phone and the IR receiver as worn on the driver's ear to thereby influence the communication quality of the cellular phone for a car driver.

The present inventor has found the drawbacks of the conventional cellular phone and the communication methods thereof as used within a car and invented the present in-car infrared receiving apparatus.

### SUMMARY OF THE INVENTION

The object of the present invention is to provide an infrared receiving apparatus including: a housing having an earphone adapted to be worn on a car driver's ear, an infrared (IR) receiver for receiving infrared signal as transmitted by an IR transmitter electrically connected to a cellular phone held in a car and for converting the IR signal to be audio signal to be heard by the car driver through the earphone as worn thereon, and a rotary shielding cover pivotally mounted in the housing and having an opening formed in a peripheral portion of the rotary shielding cover having a pendulum weight secured to the peripheral portion of the cover as juxtapositioned to the opening, thereby causing the cover to be gravitationally pendent to constantly orient the opening of the cover downwardly to preclude the inward projection of interference sunlight, and to exclusively allow the entrance of the IR signals from the cellular phone through the opening as gravitationally positioned at a bottom of the shielding cover to prevent from unexpected interference lights and to maintain a good communication quality for cellular-phone talk when driving a car.

### BRIEF DESCRIPTION OF THE DRAWINGS

FIG. 1 is an illustration showing the elements of the present invention.

FIG. 2 is an exploded view of the elements of the present invention.

FIG. 3 is a sectional drawing of the present invention.

FIG. 4 is a circuit diagram of the infrared transmitter in the present invention.

FIG. 4A is a block diagram of the infrared transmitter as shown in FIG. 4.

FIG. 5 shows a circuit diagram of the infrared receiver of the present invention.

### DETAILED DESCRIPTION

As shown in the drawing figures, the in-car infrared receiving apparatus 100 of the present invention comprises: a housing 1, an infrared (IR) receiver 2 secured in the housing 1 for receiving infrared signals as transmitted from an infrared transmitter 4 electrically connected to a cellular phone P held in a car, and a rotary shielding means 3 pivotally mounted in the housing 1 for precluding unexpected interference incoming lights including sunlight.

The housing 1 may be formed with a plastic front cover defining an interior 11 therein, having a back cover 12 made of opaque material without transmitting light therethrough and secured to a back or rear portion of the housing 1. The front cover of the housing 1 may also be made of transparent or translucent material, but not limited in this invention. The housing 1 has an IR transmittible bottom portion or opening formed in the bottom of the housing 1.

The shapes and structures of the housing 1 are not limited in the present invention. The housing 1 should, however, be designed and made to be a compact light unit for a convenient wearing on the car driver's ear or attaching to the driver's head.

The infrared receiver 2 includes: an infrared receiving circuit board 21 having an infrared receiving circuit integrally formed on the board 21 which is fixed to the back cover 12 of the housing 1, a photodiode 22 electrically connected with the infrared receiving circuit and mounted on the board 21 for receiving IR signal as transmitted from the infrared transmitter 4 mounted in a car, a hole 23 formed in the board 21 in the IR receiver 2 for pivotally or rotatably mounting the rotary shielding means 3 therein, and an earphone 24 formed on the housing 1 especially on the back cover 12 of the housing 1 adapted to be worn on or inserted in a driver's ear and adapted for transferring an audio signal, as converted from the IR signal as received by the receiver 2, to the driver's ear; with the IR receiving circuit powered by a battery (such as a button cell) 20 held on the board 21.

The rotary shielding means 3 includes: a shielding cover 31 made of opaque material for shielding interference light including sunlight and having an axle 32 axially formed in the shielding cover 31 and rotatably engaging with a sleeve member 33 having a bearing formed thereon and secured in the hole 23 of the IR receiving circuit board 21 of the receiver 2 for rotatably or pivotally mounting the shielding cover 31 on the board 21 in the housing 1, an opening 35 formed in a peripheral portion of the shielding cover 31, and a pendulum weight 36 fixed on the peripheral portion of the shielding cover 31 juxtapositioned to the opening 35; with the pendulum weight 36 having its gravity-center line being perpendicular to the axle 32 of the shielding cover 31 for allowing the shielding cover 31 to be gravitationally pendent to constantly orient the opening 35 downwardly to be gravitationally positioned at a bottom portion of the cover 31 to allow the IR signal entering the receiver 2 through the opening 35 and through an IR transmittible bottom portion (or an opening) of the housing 1.

The shielding cover 31 may be formed as a cylindrical cover having a cylindrical side wall 34 circumferentially disposed around the shielding cover 31 and having the opening 35 notched in the cylindrical side wall 34.

Other modifications may be made to rotatably pivotally mount the shielding means 3 on the circuit board 21 and on the housing 1, not limited in this invention.

The infrared transmitter 4 includes: an infrared (IR) transmitting circuit 41 mounted in a car and electrically connected to a cellular phone P held in the car through an audio-signal wire 40 for converting the audio signal S₁ from the cellular phone P to be pulse (electric) energy, and a plurality of infrared emitting diodes 42 electrically connected with the IR transmitting circuit 41 for converting the pulse energy of the audio signal to be infrared photo-wave pulse or infrared signal R₁ which is then transmitted to the IR receiver 2.

The cellular phone P is embedded or held in the car and electrically connected to a power supply source P.S. of the car, having audio wires P₁ connected between the phone P and a microphone P₂ for transferring the audio signal with wires.

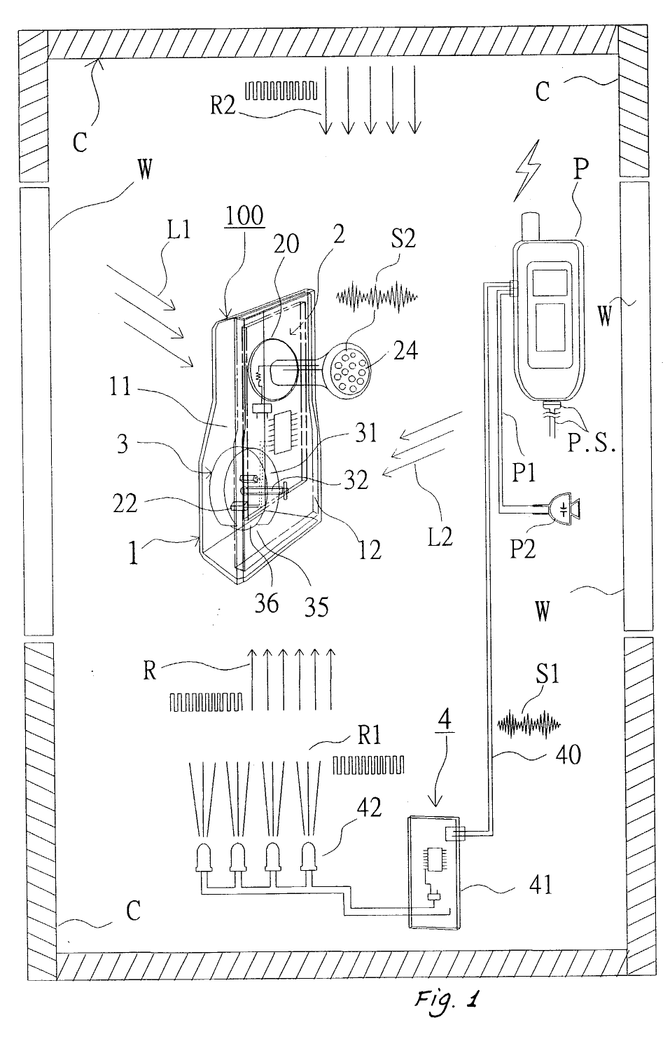

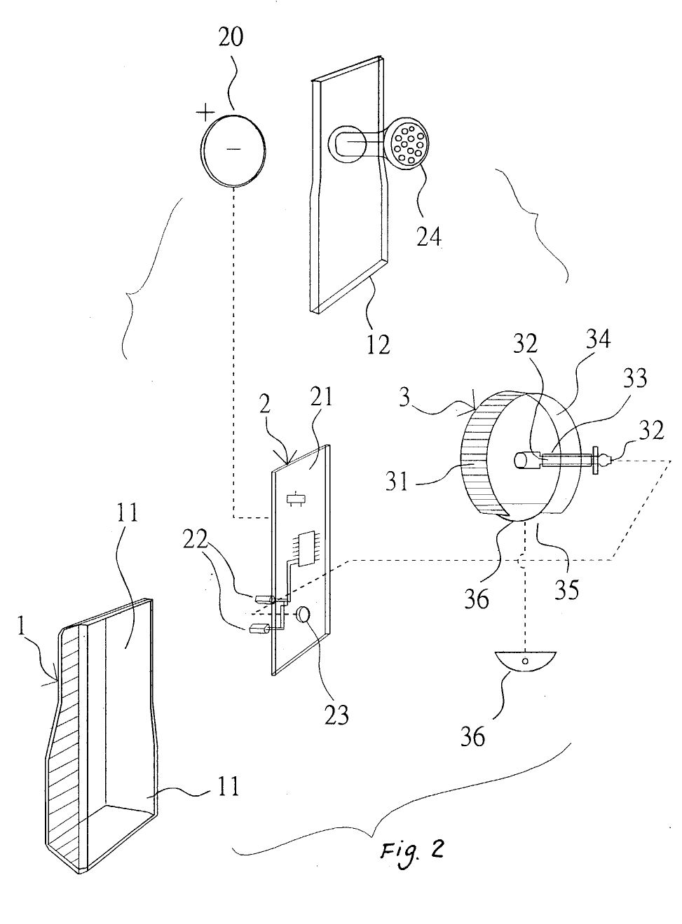

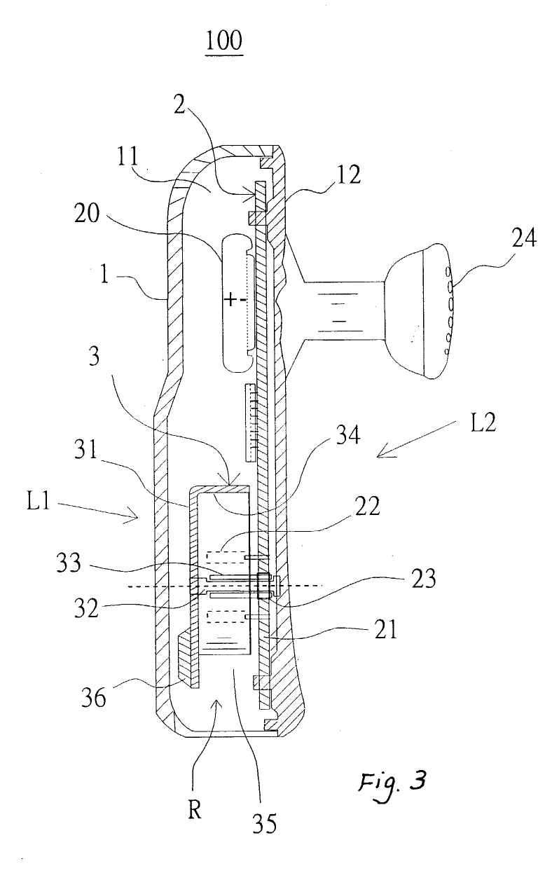

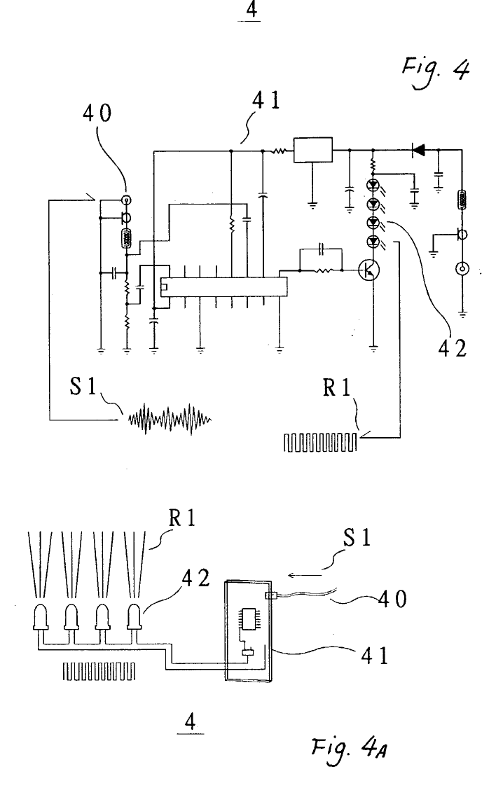

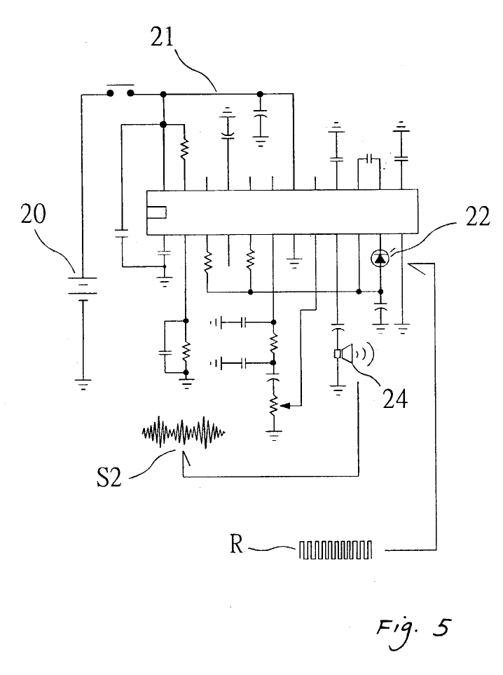

When ringing a phone call from the cellular phone P in a car C as shown in FIG. 1, the audio signal S₁ from the wire 40 connected between the phone P and the IR transmitting circuit 41 will be converted into pulse energy which, in turn, will be converted as IR signal (or IR light-wave pulse) R₁ and transmitted through the IR emitting diodes 42 to the IR receiver 2 (i.e. a wireless transmission).

Since the weight 36 of the shielding cover 31 is always or constantly pendent downwardly to orient the opening 35 downwardly, the incoming sunlight L₁, L₂ as projected inwardly through the car windows W will be shielded by the opaque shielding cover 31, the opaque board 21 and the opaque back cover 12 of the housing 1 so that only the IR rays R as upwardly transmitted through the opening 35 may enter the interior 11 in the shielding cover 31 to be received by the photodiode 22 of the IR receiver 2. The IR rays R may be a combination of the IR signal R₁ directly emitted from transmitter 2 and the IR signal R₂ reflected from the car body C. In other words, the sunlight L₁, L₂ as projected into the car body C through the windows W will be precluded beyond the shielding cover 31 to prevent from the interference of those strong IR rays existing in the sunlight. The “weak” IR signal transmitted from the IR transmitter 4 and emitted from the cellular phone P will then be transmitted (R₁) or reflected (R₂) as shown in FIG. 1 to enter the shielding cover 31 through the “bottom” opening 35 of the shielding means 3 and through IR transmittible bottom portion of the housing 1 for a reliable receiving by the receiver 2.

Since the rotary shielding means 3 is pendently held in the housing 1 to always orient the opening 35 downwardly, the incoming sunlight as projected into the car through the windows W will be shielded by the shielding cover 31, 34; and the IR rays even after being reflected in multiple directions will enter the receiver 2 through the opening 35 notched in the shielding cover 31, no matter that the car driver may vary his or her pose, or may temporarily move his or her body, or may even change the wearing locations on the driver's head.

Therefore, the present invention may reliably receive IR signals from a cellular phone within a car to increase the operational reliability of the cellular phone for a car driver. The environmental IR interference sources from outside the car may be precluded by the car body C and will not enter the car.

The present invention may be modified without departing from the spirit and scope of the present invention.

I claim:

1. An infrared receiving apparatus comprising: a housing having an earphone adapted to be worn on a car driver's ear; an infrared (IR) receiver for receiving infrared signal as transmitted by an IR transmitter electrically connected to a cellular phone held in a car, said IR receiver operatively converting the IR signal to be audio signal to be heard by the car driver through the earphone as worn thereon; and a rotary shielding means pivotally mounted in the housing and having an opening formed in a peripheral portion of the rotary shielding means having a pendulum weight secured to the peripheral portion of the shielding means as juxtapositioned to said opening, thereby allowing said shielding means to be gravitationally pendent to constantly orient the opening of the shielding means downwardly to preclude a projection of sideward incoming interference sunlight from a car window, and to exclusively allow the entrance of the IR signal from the cellular phone into the IR receiver through the opening as gravitationally positioned at a bottom portion of the shielding means and through an IR transmittible bottom portion of said housing to prevent from unexpected sunlight interference within the car.

2. An infrared receiving apparatus according to claim 1, wherein said housing is formed with a front cover defining an interior for mounting said IR receiver therein, having a back cover made of opaque material and secured to a rear portion of the housing for precluding light transmitted through said back cover.

3. An infrared receiving apparatus according to claim 2, wherein said infrared receiver includes: an infrared receiving circuit board having an infrared receiving circuit integrally formed on the board which is fixed to the back cover of the housing, at least a photodiode electrically connected with the infrared receiving circuit and mounted on the board for receiving IR signal as transmitted from the infrared transmitter mounted in a car, and an earphone formed on the back cover of the housing adapted to be worn on or inserted in a driver's ear and adapted for transferring an audio signal, as converted from the IR signal as received by the receiver, to the driver's ear; with the IR receiving circuit powered by a battery held on the board.

4. An infrared receiving apparatus according to claim 1, wherein said rotary shielding means includes: a shielding cover made of opaque material for shielding interference light including sunlight and having an axle axially formed in the shielding cover and rotatably engaging with a sleeve member and secured to an IR receiving circuit board of the IR receiver for rotatably or pivotally mounting the shielding cover on the board and on the housing, an opening formed in a peripheral portion of the shielding cover, and a pendulum weight fixed on the peripheral portion of the shielding cover and juxtapositioned to the opening; with the pendulum weight having its gravity-center line being perpendicular to the axle of the shielding cover for allowing the shielding cover to be gravitationally pendent to constantly orient the opening downwardly to be gravitationally positioned at a bottom portion of the shielding cover to allow the IR signal entering the receiver from the IR transmitter through the opening.

5. An infrared receiving apparatus according to claim 4, wherein said shielding cover is formed as a cylindrical cover having a cylindrical side wall circumferentially disposed around the shielding cover and having the opening notched in the cylindrical side wall.

6. An infrared receiving apparatus according to claim 3, wherein said infrared transmitter includes: an infrared transmitting circuit mounted in a car and electrically connected to a cellular phone held in the car through an audio-signal wire for converting the audio signal from the cellular phone to be pulse energy, and a plurality of infrared emitting diodes electrically connected with the IR transmitting circuit for converting the pulse energy of the audio signal to be infrared photo-wave pulse or infrared signal which is then transmitted to the IR receiver.
